(19) United States
(12) Patent Application Publication
(10) Pub. No.: US 2025/0124411 A1
(43) Pub. Date: Apr. 17, 2025

(54) SYSTEM AND METHODS FOR REAL-TIME PROCESSING OF SCHEDULING REQUESTS

(71) Applicant: Anthony George TULAI, Toronto (CA)

(72) Inventor: Anthony George TULAI, Toronto (CA)

(21) Appl. No.: 18/485,868

(22) Filed: Oct. 12, 2023

(51) Int. Cl. G06Q 10/1093

(52) U.S. Cl. CPC G06Q 10/1095

(57) ABSTRACT

A computer-implemented method is disclosed. The method includes: receiving, via a first computing device associated with a first user, proposed location information for a meeting; determining a plurality of second users who are matched with the first user based on a user matching process; transmitting, to second computing devices associated with the plurality of second users, a meeting invitation containing the proposed location information; receiving, via at least one of the second computing devices, a response indicating acceptance of the meeting invitation; and providing, on each of the first computing device and the at least one second computing device, a meeting manager interface in connection with the meeting, the meeting manager interface being configured to indicate identities of the first user and one or more second users associated with the at least one second computing device.

### TECHNICAL FIELD

The present application relates to data communications and, more particularly, to a system and methods for real-time processing of scheduling requests.

### BACKGROUND

In certain contexts, it is desired to process scheduling requests in real-time, in order to prevent undue delays and missed potential engagements. By way of example, a usage schedule for a computing resource, such as a processor unit or memory, may indicate allocations of the resource for use by one or more nodes of a network (e.g., computing devices in a computer network). The usage schedule may be dynamically updated as new requests to use the resource are received from network nodes or as alternative allocations of the resource are determined. Any lags in scheduling usage of the resource may result in misallocation of the available overall resource capacity of the network.

As another example, various online services, such as dating apps, social networks, and freelancing platforms, provide a matching process for determining matches among users of the service. Certain matched users may wish to arrange for in-person meetings. Scheduling meetings for a given user typically involves a manual process of inviting each individual with whom the user matched, one-by-one, to separate meetings. When scaled to a large number of user matches, this manual process can be time-consuming and resource-intensive, and may increase the likelihood of missed potential meetings.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2A is high-level schematic diagram of a computing device;

FIG. 2B shows a simplified organization of software components stored in a memory of the computing device of FIG. 2A;

FIG. 3 shows, in flowchart form, an example method for processing a scheduling request based on user input of proposed location information;

FIG. 4 shows, in flowchart form, an example method for processing a scheduling request based on user input of a proposed time and location criteria;

FIG. 5 shows, in flowchart form, another example method for processing a scheduling request based on user input of proposed location information; and

FIG. 6 shows, in flowchart form, another example method for processing a scheduling request based on user input of a proposed time and location criteria.

Like reference numerals are used in the drawings to denote like elements and features.

### DETAILED DESCRIPTION OF VARIOUS EMBODIMENTS

In an aspect, the present disclosure describes a computer-implemented method. The method includes: receiving, via a first computing device associated with a first user, proposed location information for a meeting; determining a plurality of second users who are matched with the first user based on a user matching process; transmitting, to second computing devices associated with the plurality of second users, a meeting invitation containing the proposed location information; receiving, via at least one of the second computing devices, a response indicating acceptance of the meeting invitation; and providing, on each of the first computing device and the at least one second computing device, a meeting manager interface in connection with the meeting, the meeting manager interface being configured to indicate identities of the first user and one or more second users associated with the at least one second computing device.

In some implementations, the method may further include receiving, via the first computing device, first meeting criteria, and the meeting invitation may include an indication of the first meeting criteria.

In some implementations, the first meeting criteria may relate to one or more of: travel time to the proposed location; preferred payment arrangement; or proposed meeting agenda.

In some implementations, the method may further include in response to receiving the response indicating acceptance of the meeting invitation, providing, on the first computing device, a notification of the response.

In some implementations, the method may further include receiving, via the first computing device, confirmation of the meeting by the first user, and the meeting manager interface may be provided on each of the first computing device and the at least one second computing device responsive to receiving the confirmation.

In some implementations, the confirmation of the meeting may include a selection, by the first user, from a list enumerating the plurality of second users.

In some implementations, the response indicating acceptance of the meeting invitation may be received from a plurality of second computing devices and providing the meeting manager interface may include selecting one of the second computing devices in accordance with defined selection criteria.

In some implementations, the defined selection criteria may relate to one or more of: proximity to the proposed location; time of arrival at the proposed location; time of responding to the meeting invitation; or subscription status of the second users.

In some implementations, the meeting manager interface may include a selectable option for indicating an expected time of arrival at the proposed location.

In some implementations, the method may further include: providing, via the meeting manager interface on the first computing device and the at least one second computing device, a prompt for confirmation of arrival status of the one or more second users and the first user, respectively; obtaining current location data associated with the first user and the one or more second users; and determining meeting attendance status of the first user and the one or more second users based on the confirmations and the current location data.

In another aspect, the present disclosure describes a computer-implemented method. The method includes: receiving, via a first computing device associated with a first user, a proposed time for a meeting and location criteria; determining a plurality of second users who are matched with the first user based on a user matching process; transmitting, to second computing devices associated with the plurality of second users, a meeting invitation indicating the proposed time; receiving, via at least one of the second computing devices, a response indicating acceptance of the meeting invitation, the response including selection of a first location that satisfies the location criteria; and providing, on each of the first computing device and the at least one second computing device, a meeting manager interface in connection with the meeting, the meeting manager interface being configured to indicate identities of the first user and one or more second users associated with the at least one second computing device.

Other aspects and features of the present application will be understood by those of ordinary skill in the art from a review of the following description of examples in conjunction with the accompanying figures. Example embodiments of the present application are not limited to any particular operating system, system architecture, mobile device architecture, server architecture, or computer programming language.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

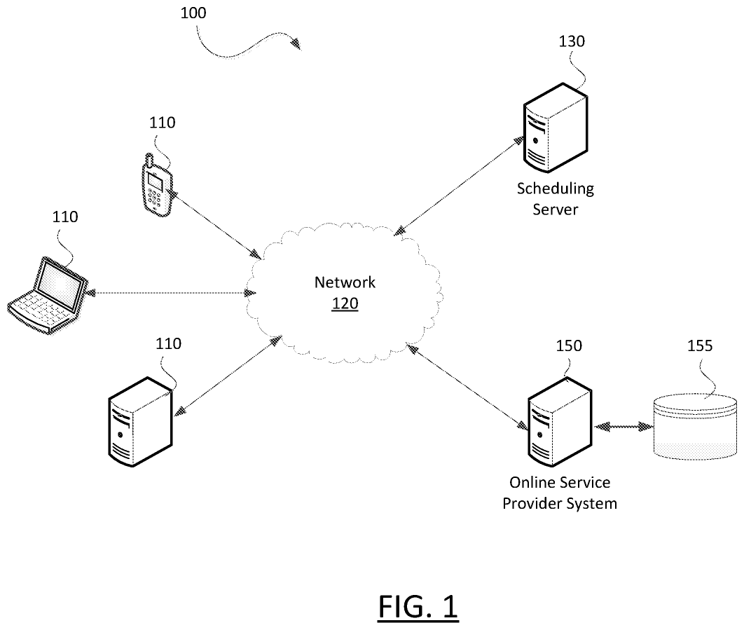

Reference is first made to FIG. 1, which is a schematic diagram illustrating an operating environment of an example embodiment. FIG. 1 illustrates exemplary components of a system 100 for processing scheduling requests. As a specific example, the system 100 may be configured to determine, in real-time, a usage schedule of a resource, such as a computing resource (e.g., processor units, memory, data storage, etc.). The usage schedule may indicate allocations of the resource for use by one or more nodes of a network, such as a computer network. In particular, the usage schedule may specify, for each of one or more network nodes, a time of use of the resource by the node and nature of the use (e.g., partial use, etc.).

By way of another example, the system 100 may facilitate determining, in real-time, a schedule of meetings between matched users of an online service. As will be explained in greater detail below, the components of system 100 may support scheduling meetings for a plurality of users, based on structured distribution of message data between computing devices associated with the users. The schedule of meetings for a requesting user may be determined in real-time based on, for example, location information associated with a client device, which may be automatically determined or manually input by the user.

As illustrated, the scheduling server 130 and one or more client devices 110 communicate via the network 120. The client device 110 is a computing device. For example, the client device 110 may be a device of an entity having resources that are associated with the scheduling server 130. The client device 110 may take a variety of forms including, for example, a mobile communication device such as a smartphone, a tablet computer, a wearable computer such as a head-mounted display or smartwatch, a laptop or desktop computer, or a computing device of another type.

The scheduling server 130 is configured to process, in real-time, scheduling requests received from client devices 110. More particularly, the scheduling server 130 may receive, from one or more client devices 110, requests from users to determine schedules in real-time. The scheduling requests may include one or more schedule parameters identified by users associated with the client devices 110. The scheduling requests may relate to various different types of schedules such as, but not limited to, usage schedule of resources (e.g., computing resources), meeting schedules for matched users of an online service, and the like. The scheduling server 130 may coordinate communications to and between client devices 110 in order to perform scheduling operations such as generating proposed schedules, obtaining confirmation(s) of proposed schedules, and selectively distributing confirmed schedule data to one or more client devices 110.

In some implementations, the scheduling server 130 may access data stored in one or more databases when generating schedules. For example, when processing requests to schedule meetings between users of an online service, the scheduling server 130 may be configured to access a database storing matched user data for a plurality of users of the online service. The matched user data may include, for each of one or more user matches: identifying information of users who are matched, matching criteria, time of initial match, meeting status of the matched users, etc.

The system 100 includes at least one online service provider system 150. The online service provider system 150 is a computing system that runs web-based services or applications. In particular, the online service provider system 150 may host one or more web services (or service applications). For example, the online service provider system 150 may implement a backend for a service application that is executable on client devices 110.

The online service provider system 150 may accept requests via a network protocol (e.g., Hypertext Transfer Protocol). A user agent, such as a web browser or mobile app, on a client device 110 may request for a specific resource using HTTP, and the online service provider system 150 may respond to the request by providing content associated with the requested resource (or a suitable error message). The online service provider system 150 may also be configured to receive and store resources that are sent via the client devices 110. The online service provider system 150 may comprise a single computer, an embedded system, or a collection of computers.

In at least some embodiments, user information for users of the online service may be stored in a data store, such as a database 155. The user information may include, for example, profile information (e.g., name, current location, etc.), user preferences in relation to various characteristics (e.g., interests, height, age, weight, sex, income, profession, etc.), matched user data, authentication credentials, account settings data, historical service usage data, and the like.

While the scheduling server 130 is illustrated in FIG. 1 as being external to the online service provider system 150, it will be understood that the scheduling server 130 may be integrated with the online service provider system 150, in some embodiments. By way of example, the scheduling server 130 may be implemented as a component, such as a software module, of the online service provider system 150. More generally, the functions of the scheduling server 130 may be provided as part of scheduling services that are implemented by the online service provider system 150.

The client devices 110, the scheduling server 130, and the online service provider system 150 may be in geographically disparate locations. Put differently, the client devices 110 may be located remotely from the scheduling server 130 and the online service provider system 150. As explained herein, the client devices 110, the scheduling server 130, and the online service provider system 150 are computing systems.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

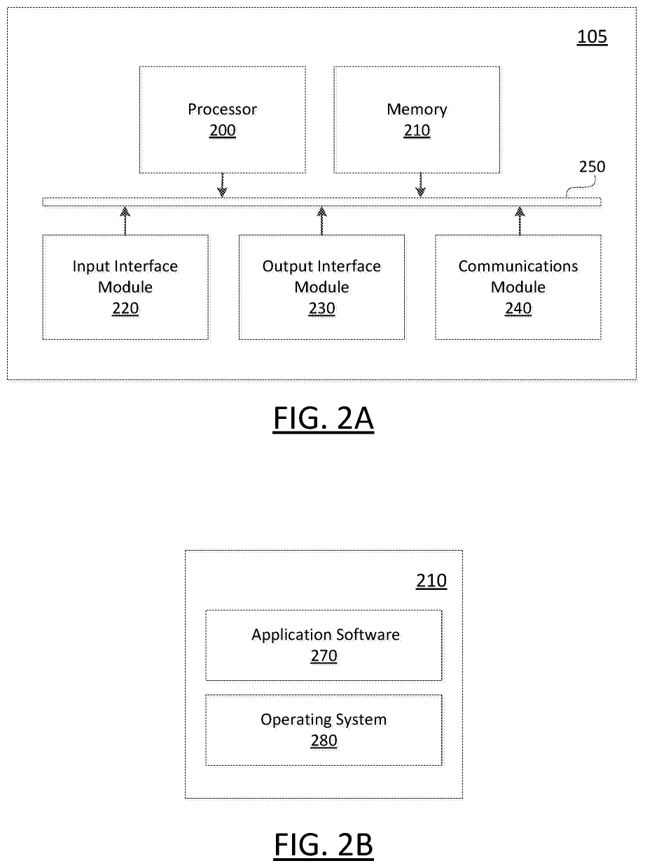

FIG. 2A is a high-level operation diagram of an example computing device 105. In at least some embodiments, the example computing device 105 may be exemplary of one or more of the scheduling server 130, the online service provider system 150, and the client devices 110. The example computing device 105 includes a variety of modules. For example, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM™, Intel™ x86, PowerPC™ processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards.

For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components include application software 270 and an operating system 280.

The application software 270 adapts the example computing device 105, in combination with the operating system 280, to operate as a device performing a particular function. In some embodiments, the application software 270 may comprise a social networking application, such as a dating app. The application software 270 may enable users of a social network (or another online platform) to connect and interact online. For example, users of an online dating service may use the application software 270 to set up a dating profile, specify dating preferences, access and indicate preference/interest in relation to dating profiles of other users, and communicate with matched users of the online dating service.

In accordance with example embodiments of the present disclosure, the application software 270 may provide scheduling functionalities for managing the scheduling of meetings using a client device 110. For example, the application software 270 may incorporate various functionalities of a schedule request processing system, such as the scheduling server 130 of FIG. 1. A user of an online service may input, via the application software 270, a request to process scheduling of meetings with one or more matched users of the online service. For example, the user may input proposed location information, a proposed time or time window, and/or location criteria as part of request parameters for a scheduling request. The application software 270 may be configured to generate a proposed schedule for one or more meetings, obtain confirmation(s) of the meetings, and provide confirmed participants of the meetings, with tools for managing the meetings. The proposed schedule may, for example, include information relating to one or more confirmed meetings for the requesting user, such as meeting participants, location, date and time of the meetings, and the like.

The operating system 280 is software. The operating system 280 allows the application software 270 to access the processor 200, the memory 210, the input interface module 220, the output interface module 230 and the communications module 240. The operating system 280 may be, for example, Apple iOS™, Google's Android™, Linux™, Microsoft Windows™, or the like.

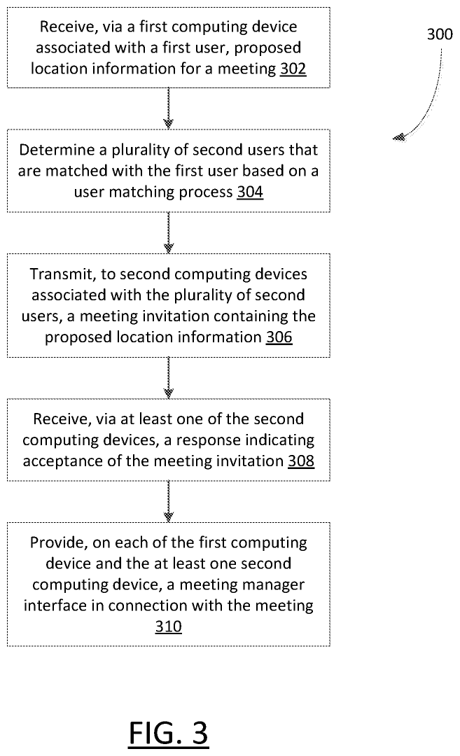

Reference is now made to FIG. 3, which shows, in flowchart form, an example method 300 for processing a scheduling request based on user input of proposed meeting location information. The method 300 may be implemented by a scheduling processing system, such as the scheduling server 130 of FIG. 1. As a specific example, the operations of method 300 may be performed by a scheduling server 130 when processing requests to schedule meetings between matched users of an online service.

Operations starting with operation 302 and continuing onward may be performed, for example, by the processor 200 (FIG. 2A) of a computing device 105 executing software comprising instructions, such as may be stored in the memory 210 of the computing device 105. Specifically, processor-executable instructions may, when executed, configure a processor 200 of a scheduling server 130 to perform all or parts of the method 300.

An online service, such as a social networking or online dating platform, may be accessed using a user interface (e.g., a mobile app) on a client device. More particularly, a user of the online service may use a graphical user interface associated with the service to access various features of the service. The online service may provide a user matching functionality. The users of the online service may be matched (or otherwise connected) automatically, based on a defined matching mechanism implemented by the service. Additionally, or alternatively, the users may be matched based on actions performed by the users. For example, users may indicate preference or interest toward other users of the service by performing one or more defined actions, and users who express mutual preference/interest may be matched with each other.

Once a first user of the online service has matched with at least one other user, the first user may wish to schedule in-person meetings with one or more of their matched users. The first user may request, via the user interface, for a meeting to be scheduled with at least one matched user. In operation 302, the scheduling server receives, via a first computing device associated with the first user, proposed location information for a meeting. In particular, location information is received as a request parameter of a scheduling request by the first user. The proposed location information may be manually input by the first user. For example, the first user may select a place, such as an establishment, geographic location, or prominent point of interest. The selection may be made using a map interface, a user interface element (e.g., a dropdown list), or a location search functionality that is accessible on the client device (e.g., within the graphical user interface for the online service). Additionally, or alternatively, the proposed location may be automatically determined, without manual input by the first user. For example, a current location associated with the first computing device may be automatically detected, by the first computing device and/or the scheduling server, using GPS, triangulation using cellular radio signals, etc.

In some implementations, the first user may input additional request parameters in connection with the meeting. The scheduling server may receive, via the first computing device, first meeting criteria for the meeting. The first meeting criteria may relate to one or more of: estimated travel time to the proposed location; preferred payment method and/or arrangement; proposed meeting agenda (e.g., proposed activities); type of meeting; ideal meeting length; etc.

In operation 304, the scheduling server determines a plurality of second users who are matched with the first user based on a user matching process. That is, the scheduling server determines the identities of users of the online service who have been matched with the first user. The user matching process may be implemented by the online service. For example, the online service may be configured to display profiles of potential matches to users, who can perform defined actions (e.g., swiping left or right) to indicate interest or non-interest. When two or more users indicate mutual interest, a user match may be formed.

In at least some implementations, the scheduling server may access a database storing matched user information for a plurality of users of the online service. The scheduling server may be configured to query the database in order to retrieve identifying information for one or more second users who have been matched with the first user. The identifying information may include, for example, given name, nickname/user ID, personal bio, contact details (e.g., email address, phone number, etc.), interests, political leaning(s), family plans, account information, date and time of matching with the first user, and the like.

The scheduling server transmits, to second computing devices associated with the plurality of second users, a meeting invitation containing the proposed location information, in operation 306. The meeting invitation may, in some implementations, be a message object containing message data relating to the meeting. The meeting invitation may include additional request parameters (e.g., preferred payment method and/or arrangement) which are specified by the first user. The identity of the first user may or may not be indicated in the meeting invitation. In particular, the meeting invitation may indicate that a source of the scheduling request is a user who has matched with a recipient of the meeting invitation (i.e., a second user), but the actual identity of said source may not be disclosed in the meeting invitation.

The scheduling server broadcasts the meeting invitation to the second computing devices such that the invitation can be extended to all or a subset of the users who have been matched with the first user. In this way, a single global invitation containing proposed meeting details specified by the first user is distributed to multiple matched users, avoiding the need to send a series of individual invitations to said users. The meeting invitation may be communicated to the second computing devices in one or more different formats, such as an in-app notification, email, text message, etc. For example, a push notification indicating that a meeting invitation has been sent by a matched user may be provided via an application on the second computing devices.

One or more of the second users, i.e., users matched with the first user, can “claim” a meeting at the proposed location by providing a response to the meeting invitation. In operation 308, the scheduling server receives, via at least one of the second computing devices, a response message indicating acceptance of the meeting invitation. The response represents a confirmation, by the second user(s) associated with the at least one second computing device, of an intention to meet with the first user at the proposed location. In some implementations, the response message may comprise a reply to a prompt that is provided, via the user interface of the online service, on the second computing devices. For example, a second user may respond to a meeting invitation that is presented on their device by selecting an UI element corresponding to an option for accepting the invitation to the proposed meeting.

In some implementations, the scheduling server may notify the first user when a response to the meeting invitation has been received. That is, responsive to receiving a response indicating acceptance of the meeting invitation, the scheduling server may provide, on the first computing device, a notification regarding the received response. A single notification may be provided for multiple different responses to the meeting invitation; the notification may indicate, for example, a number of responses received. Alternatively, each received response may cause a new notification to be provided on the first computing device.

After a response to the meeting invitation is received by the scheduling server, the user interface of the online service may be caused to switch to a “go to meeting” state on the first computing device and at least one of the second computing devices. In this state, the user interface may present the confirmed participants of the meeting, i.e., the first user and at least one responding second user, with tools for managing the meeting. The user interface may switch to this state immediately upon first receipt of a response to the meeting invitation, or at a different time (e.g., a time indicated in the meeting invitation).

In operation 310, the scheduling server provides, on each of the first computing device and the at least one second computing device, a meeting manager interface in connection with the meeting. The meeting manager interface may be configured to indicate the location of the meeting and/or the identities of the confirmed meeting participants, i.e., the first user and a second user who is associated with the at least one second computing device. In some implementations, the meeting manager interface includes a selectable option for indicating an expected time of arrival at the meeting location. The option may be presented, for example, in the form of one or more UI elements that enable each participant of the meeting to indicate if they are running late and/or an updated arrival time at the proposed location. Other options for indicating specific details of the meeting, such as precise location of meeting, participant identifying features (e.g., outfit worn by participant), etc., may be provided via the meeting manager interface.

In some instances, multiple different ones of the second users may respond to the meeting invitation. In particular, a response indicating acceptance of the proposed meeting may be received from a plurality of second computing devices. The scheduling server may, in such cases, be configured to automatically select one of the second computing devices in accordance with defined selection criteria. That is, only one of the responding second users may be selected for the meeting at the proposed location with the first user. The meeting manager interface may then be provided only on the second computing device associated with the selected second user. The selection criteria are thus used to determine a ranking of the users responding to the meeting invitation, and the second user for the proposed meeting may be selected based on the ranking. In at least some implementations, the selection criteria may relate to one or more of the second user's: proximity to the proposed location; time of arrival at the proposed location; time of responding to the meeting invitation; or online service subscription status.

The confirmed participants of the meeting may be prompted for various information relating to the status of the meeting. In particular, the prompts may be provided to the participants before, during, or after the time of the meeting. A participant may be prompted to indicate, for example, if the other participant(s) have arrived at the proposed meeting location. In some implementations, the scheduling server may provide, via the meeting manager interface on the devices of the meeting participants, a prompt for input confirming arrival status of the participants. The scheduling server may, for example, obtain current location data associated with the first user and the one or more second users, and determine a meeting attendance status of the confirmed participants based on the participants' confirmation inputs and current location data. The current location data may be obtained by the scheduling server directly from the first and second computing devices (e.g., based on user input of device location), or using a different mechanism (e.g., GPS, triangulation using cellular radio signals, etc.).

In some implementations, the confirmed participants may be prompted to provide information regarding perceived safety of the interaction at the meeting or other questions to assess the quality of the interaction. The meeting manager interface may include, at least, an option to share contact details after the interaction at the meeting and/or an option to schedule another meeting between the confirmed participants. Other information which may be offered by the participants, such as profile accuracy of the other participant, a review of the meeting or participant, etc., may be input using the meeting manager interface.

Additionally, or alternatively, the meeting manager interface may facilitate interaction during the meeting. For example, the meeting manager interface may display one or more prompts for conversation or other displayable cues for encouraging interaction and/or facilitating progress toward completion of the meeting. The prompts and/or cues may be provided via the meeting manager interface upon participant confirmation, or detection by the server, that the meeting is underway.

While the description of method 300 refers to processing a scheduling request for a single first user, it will be understood that the method 300 is applicable in cases of multiple first users who each request for a meeting to be scheduled with at least one of their respective matched second users. For example, in some implementations, two or more first users may request to schedule “joint meetings” in which the first users jointly meet with two or more of the second users. Each second user may be identified in accordance with the technique described with reference to method 300—that is, for each first user requesting a joint meeting, at least one respective second user that accepts an invitation to the joint meeting may be confirmed for the meeting. The meeting invitation includes details of the joint meeting including, at least, a proposed meeting location that is specified by at least one of the first users.

The set of participants for the joint meeting is determined in accordance with the process described with reference to method 300. Specifically, the second users for the joint meeting are confirmed based on processing responses to a meeting invitation to the joint meeting, the meeting invitation being broadcasted to computing devices associated with all or a subset of the matched users of the first users. A meeting manager interface may be provided on computing devices associated with each of the two or more first users who request the joint meeting and those matched users of the first users who respond to the meeting invitation and are confirmed for the meeting.

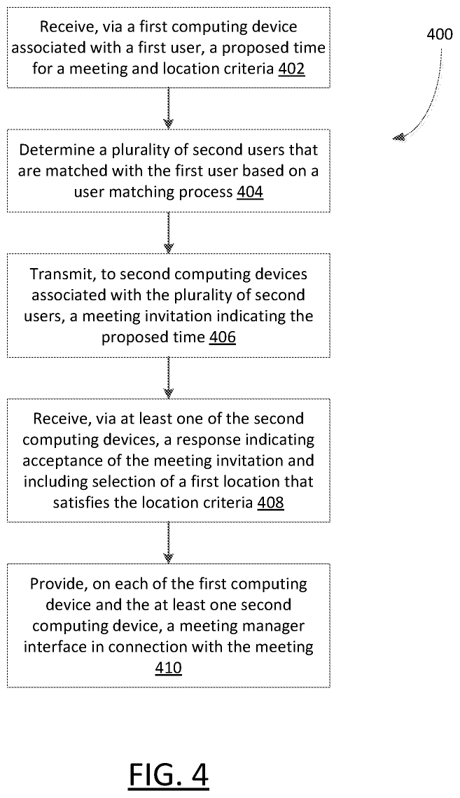

Reference is now made to FIG. 4, which shows, in flowchart form, an example method 400 for processing a scheduling request based on user input of a proposed meeting time and location criteria. The method 400 may be implemented by a schedule processing system, such as the scheduling server 130 of FIG. 1. As a specific example, the operations of method 400 may be performed by a scheduling server 130 when processing requests to schedule meetings between matched users of an online service.

Operations starting with operation 402 and continuing onward may be performed, for example, by the processor 200 (FIG. 2A) of a computing device 105 executing software comprising instructions such as may be stored in the memory 210 of the computing device 105. Specifically, processor-executable instructions may, when executed, configure a processor 200 of a scheduling server 130 to perform all or parts of the method 400. The operations of method 400 may be performed, individually or collectively, in addition to, or as alternatives of, one or more of the operations of method 300.

An online service may provide a user matching functionality. A first user of the online service may wish to schedule in-person meetings with one or more of their matched users. The first user may request, via a user interface of the online service, for meetings to be scheduled with their matched users. In operation 402, the scheduling server receives, via a first computing device associated with the first user, an indication of a proposed time (and/or time window) for a meeting and location criteria. In particular, a proposed time and location criteria may be received as request parameters of the scheduling request by the first user. The first user may indicate, for example, whether they want the meeting to occur imminently, at a specific future time, or during a defined future time window.

In some implementations, the location criteria may include an indication of maximum radius from a current or indicated location associated with the first user. That is, the first user may indicate a desire to meet at a location that is within a specific distance from the first user's current and/or indicated location. The location criteria may, for example, include a value of a threshold distance that corresponds to the first user's desired maximum radius. Additionally, or alternatively, the location criteria may include an indication of a minimum radius from a current/indicated location. For example, the location criteria may include a value of a threshold distance corresponding to the first user's desired minimum radius, indicating the first user's preference to meet at least a specific distance away from their current/indicated location.

The scheduling server may determine the current location of the first user automatically or based on input by the first user. For example, a current location associated with the first computing device may be automatically detected, by the first computing device and/or the scheduling server, using GPS, triangulation using cellular radio signals, etc. The first user may also input an indication of details of their current location, such as address, selection of a place, etc., which may then be transmitted to the scheduling server.

In some implementations, the location criteria may include a defined set of place categories. The first user may indicate one or more categories of places that are desired for the proposed meeting. Examples of place categories include cafés, bars, movie theaters, parks, and the like.

The first user may input additional request parameters in connection with the meeting. The scheduling server may receive, via the first computing device, first meeting criteria for the meeting. The first meeting criteria may relate to one or more of: estimated travel time to the proposed location; preferred payment method and/or arrangement; proposed meeting agenda (e.g., proposed activities); type of meeting; ideal meeting length; etc.

In operation 404, the scheduling server determines a plurality of second users who are matched with the first user based on a user matching process. In at least some implementations, the scheduling server may access (or query) a database storing matched user information for a plurality of users of the online service to retrieve identifying information for the plurality of second users. The identifying information may include, for example, given name, nickname/user ID, personal bio, contact details (e.g., email address, phone number, etc.), interests, political leaning(s), family plans, account information, date and time of matching with the first user, and the like.

In operation 406, the scheduling server transmits, to second computing devices associated with the plurality of second users, a meeting invitation indicating the proposed time/time window and/or location criteria. The meeting invitation may, in some implementations, be a message object containing message data relating to the meeting. The meeting invitation may include additional request parameters (e.g., preferred payment method and/or arrangement) which are specified by the first user. The identity of the first user may or may not be indicated in the meeting invitation. In particular, the meeting invitation may indicate that a source of the scheduling request is a user who has matched with a recipient of the meeting invitation (i.e., a second user), but the actual identity of said source may not be disclosed in the meeting invitation.

The scheduling server broadcasts the meeting invitation to the second computing devices such that the invitation can be extended to all or a subset of the users who have been matched with the first user. The meeting invitation may be communicated to the second computing devices in one or more different formats, such as an in-app notification, email, text message, etc. For example, a push notification indicating that a meeting invitation has been sent by a matched user may be provided via an application on the second computing devices.

One or more of the second users can “claim” a meeting at the proposed time/time window by providing a response to the meeting invitation. In operation 408, the scheduling server receives, via at least one of the second computing devices, a response indicating acceptance of the meeting invitation. The response represents a confirmation, by the second user(s) associated with the at least one second computing device, of an intention to meet with the first user at the proposed time/time window. In some implementations, the response message may comprise a reply to a prompt that is provided, via the user interface of the online service, on the second computing devices.

The response includes a selection of a first location that satisfies the location criteria. In particular, a second user who responds to the meeting invitation also provides an indication of at least one location satisfying the location criteria. In some implementations, the scheduling server may provide, on the at least one second computing device, a location selection interface. The location selection interface may be configured to display one or more meeting locations that satisfy the user-inputted location criteria. The responding second user may be prompted to select location(s) using the location selection interface. The location selection interface may, for example, display a curated list of meeting locations that are within a specific distance/radius from a current/indicated location of the first user and/or fall within the defined set of place categories specified by the first user.

As another example, the location selection interface may enable search of a database storing location information for a plurality of potential meeting venues. The search function may specify the location criteria such that only the meeting venues that satisfy said criteria are displayed via the location selection interface. The responding second user may select one or more of the locations that are returned by the search, and the selections may be received by the scheduling server.

After a response to the meeting invitation is received by the scheduling server, the user interface for the online service may be caused to switch to a “go to meeting” state on the first computing device and at least one of the second computing devices. In this state, the user interface may present the confirmed participants of the meeting, i.e., the first user and at least one responding second user, with tools for managing the meeting. The user interface may switch to this state immediately upon first receipt of a response to the meeting invitation, or at a different time (e.g., a time indicated in the meeting invitation).

In operation 410, the scheduling server provides, on each of the first computing device and the at least one second computing device, a meeting manager interface in connection with the meeting. The meeting manger interface may be configured to indicate the location of the meeting and/or the identities of the confirmed meeting participants. In some implementations, the meeting manager interface includes a selectable option for indicating an expected time of arrival at the meeting location. The option may be presented, for example, in the form of one or more UI elements that enable each participant of the meeting to indicate if they are running late and/or an updated arrival time at the proposed location. Other options for indicating specific details of the meeting, such as precise location of meeting, participant identifying features (e.g., outfit worn by participant), etc., may be provided via the meeting manager interface.

In some instances, multiple different ones of the second users may respond to the meeting invitation. In particular, a response indicating acceptance of the proposed meeting may be received from a plurality of second computing devices. The scheduling server may, in such cases, be configured to select one of the second computing devices in accordance with defined selection criteria. That is, only one of the responding second users may be selected for the meeting at the proposed time/time window with the first user. The meeting manager interface may then be provided only on the second computing device associated with the selected second user. The defined selection criteria may relate to one or more of the second user's: proximity to the proposed location; time of arrival at the proposed location; time of responding to the meeting invitation; or online service subscription status.

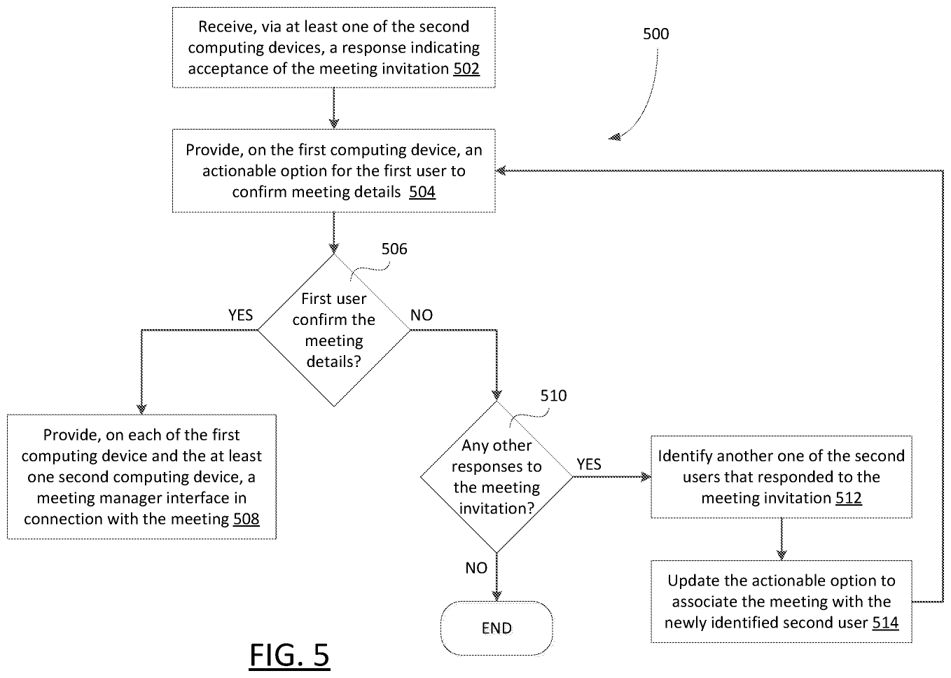

Reference is now made to FIG. 5, which shows, in flowchart form, another example method 500 processing a scheduling request based on user input of proposed location information. The method 500 may be implemented by a schedule processing system, such as the scheduling server 130 of FIG. 1. As a specific example, the operations of method 500 may be performed by a scheduling server 130 when processing requests to schedule meetings between matched users of an online service.

Operations starting with operation 502 and continuing onward may be performed, for example, by the processor 200 (FIG. 2A) of a computing device 105 executing software comprising instructions such as may be stored in the memory 210 of the computing device 105. Specifically, processor-executable instructions may, when executed, configure a processor 200 of a scheduling server 130 to perform all or parts of the method 500. The operations of method 500 may be performed, individually or collectively, in addition to, or as alternatives of, one or more of the operations of methods 300 and 400.

An online service may provide user matching functionality for matching, or otherwise connecting, users of the service. A first user of an online service may initiate a request for meetings to be scheduled with their matched users. FIG. 5 illustrates an implementation of a method for processing a scheduling request that includes soliciting and receiving confirmation by the first user in connection with a meeting at a proposed location.

Upon receiving proposed location information for a meeting, the scheduling server may be configured to broadcast a meeting invitation to a plurality of second users that are matched with the first user. The meeting invitation, which contains the proposed location information, is broadcasted to computing devices associated with the second users. The scheduling server receives meeting acceptance responses, from one or more second users, indicating acceptance of a meeting invitation (operation 502). The scheduling server then provides, on a first computing device associated with the first user, an actionable option for the first user to confirm meeting details (operation 504) for a meeting with a specific one of the second users, or “candidate” participant. The meeting details may comprise an indication of the meeting location and other information which may be provided by the candidate participant in their meeting acceptance response. The identity of the candidate participant may or may not be included in the meeting details; that is, the first user may not be presented with information identifying the candidate participant when confirming the meeting details.

In cases where multiple acceptance responses are received, the scheduling server may automatically select a candidate participant for the meeting from the set of second users who respond to the meeting invitation. The selection of the candidate participant may be based on defined selection criteria, such as proximity to the meeting location, estimated time of arrival, service subscription status, and the like. The scheduling server may select the candidate participant in accordance with a ranking of the responding second users that is determined using the selection criteria.

Alternatively, the first user may select one of the second users associated with the received responses as the candidate participant. In particular, the confirmation of the meeting may comprise a selection, by the first user, from a list enumerating a plurality of second users associated with the received responses to the meeting invitation. The list may or may not include identifying information about the responding second users. Instead, the list may include other information, such as proximity, estimated time of arrival, etc., which can be used by the first user in deciding which of the responding second users to select.

In some implementations, to facilitate the selection, the scheduling server may prompt the second users for answers to one or more defined questions. The prompts may, for example, be presented on computing devices associated with the responding second users. The questions may be designed to solicit additional information that facilitates the first user's decision of which of the responding users to meet with. The list of responding second users can, in turn, be presented to the first user, along with the respective answers to the questions from said second users. In this way, the first user can use the answers as part of the selection criteria for selecting one of the responding second users.

The meeting manager interface may be provided on the first computing device and at least one second computing device of a candidate participant only in response to determining that confirmation of the meeting by the first user is received. If the first user does not confirm (e.g., the first user cancels the meeting), the meeting manager interface is not provided on the computing devices. The first user may, for example, be presented with an actionable option for canceling the meeting. If the scheduling server receives confirmation of the meeting details (including selection of a second user) from the first user (operation 506), the scheduling server provides, on each of the first computing device and the at least one second computing device, a meeting manager interface in connection with the meeting, in operation 508.

If, however, confirmation is not received from the first user, the scheduling server performs a check to determine whether any other responses to the meeting invitation have been received (operation 510). In some implementations, the scheduling server may determine that a confirmation is not received if no confirmation is provided by the first user within a defined threshold time period. For example, if the scheduling server does not receive a confirmation from the first user within a certain amount of time from the time of receiving a meeting acceptance response from the candidate participant, the scheduling server may determine that the first user has not confirmed the meeting details.

In response to determining that there are additional meeting acceptance responses, the scheduling server identifies another one of the second users that responded to the meeting invitation as a candidate participant (operation 512). The scheduling server also updates the actionable option (for the first user to confirm the meeting details) to associate the meeting with this next candidate participant, in operation 514. This iterative process of identifying different candidate participants may be continued until the first user provides confirmation of meeting details with one of the candidate participants. At that point, the scheduling server may provide the meeting manager interface on the first computing device and a computing device of the selected candidate participant.

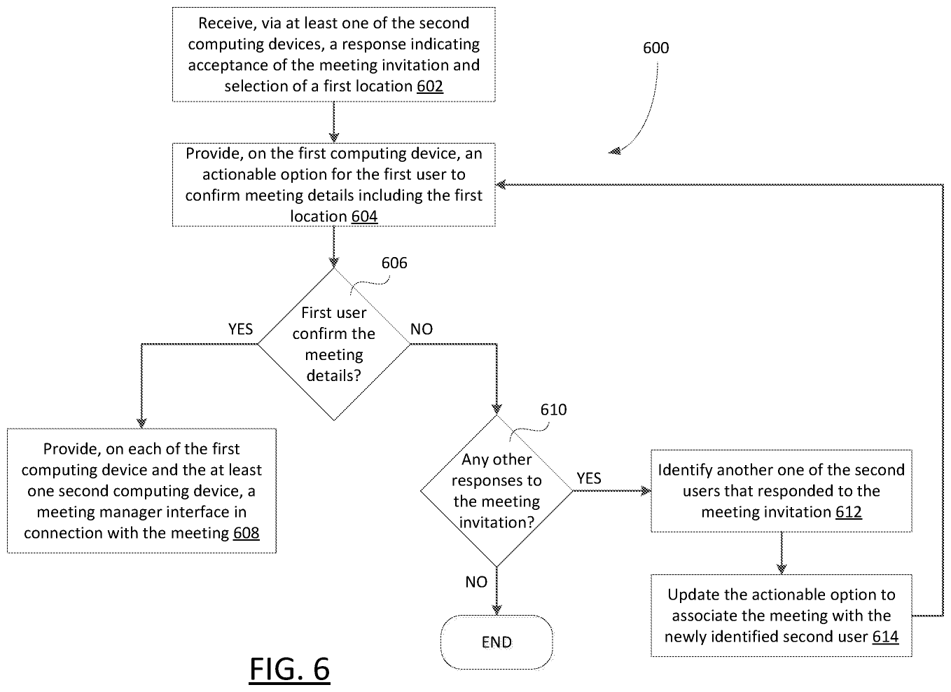

Reference is now made to FIG. 6, which shows, in flowchart form, another example method 600 for processing a scheduling request based on user input of a proposed time and location criteria. The method 600 may be implemented by a schedule processing system, such as the scheduling server 130 of FIG. 1. As a specific example, the operations of method 600 may be performed by a scheduling server 130 when processing requests to schedule meetings between matched users of an online service.

Operations starting with operation 602 and continuing onward may be performed, for example, by the processor 200 (FIG. 2A) of a computing device 105 executing software comprising instructions such as may be stored in the memory 210 of the computing device 105. Specifically, processor-executable instructions may, when executed, configure a processor 200 of a scheduling server 130 to perform all or parts of the method 600. The operations of method 600 may be performed, individually or collectively, in addition to, or as alternatives of, one or more of the operations of methods 300, 400, and 500.

An online service may provide user matching functionality for matching, or otherwise connecting, users of the service. A first user of an online service may initiate a request for meetings to be scheduled with their matched users. FIG. 6 illustrates an implementation of a method for processing a scheduling request that includes soliciting and receiving confirmation by the first user in connection with a meeting at a proposed time (or time window) and at a location satisfying defined location criteria.

Upon receiving proposed time/time window information for a meeting, the scheduling server may be configured to broadcast a meeting invitation to a plurality of second users that are matched with the first user. The meeting invitation, which contains the proposed time information, is broadcasted to computing devices associated with the second users. The scheduling server receives meeting acceptance responses, from one or more second users, indicating acceptance of a meeting invitation (operation 602). The scheduling server then provides, on a first computing device associated with the first user, an actionable option for the first user to confirm the meeting details (operation 604) for a meeting with a specific one of the second users, or “candidate” participant. The meeting details may comprise an indication of the meeting time/time window, a location satisfying the defined location criteria, and other information which may be provided by the candidate participant in their meeting acceptance response. The identity of the candidate participant may or may not be included in the meeting details; that is, the first user may not be presented with information identifying the candidate participant when confirming the meeting details.

In cases where multiple acceptance responses are received, the scheduling server may automatically select a candidate participant for the meeting from the set of second users who respond to the meeting invitation. The selection of the candidate participant may be based on defined selection criteria, such as proximity to the meeting location, estimated time of arrival, service subscription status, and the like. The scheduling server may select the candidate participant in accordance with a ranking of the responding second users that is determined using the selection criteria.

Alternatively, the first user may select one of the second users associated with the received responses as the candidate participant. In particular, the confirmation of the meeting may comprise a selection, by the first user, from a list enumerating a plurality of second users associated with the received responses to the meeting invitation. The list may or may not include identifying information about the responding second users. Instead, the list may include other information, such as proximity, estimated time of arrival, etc., which can be used by the first user in deciding which of the responding second users to select.

In some implementations, to facilitate the selection, the scheduling server may prompt the second users for answers to one or more defined questions. The prompts may, for example, be presented on computing devices associated with the responding second users. The questions may be designed to solicit additional information that facilitates the first user's decision of which of the responding users to meet with. The list of responding second users can, in turn, be presented to the first user, along with the respective answers to the questions from said second users. In this way, the first user can use the answers as part of the selection criteria for selecting one of the responding second users.

The meeting manager interface may be provided on the first computing device and at least one second computing device of a candidate participant only in response to determining that confirmation of the meeting by the first user is received. If the first user does not confirm (e.g., the first user cancels the meeting), the meeting manager interface is not provided on the computing devices. The first user may, for example, be presented with an actionable option for canceling the meeting. If the scheduling server receives confirmation of the meeting details (including selection of a second user) from the first user (operation 606), the scheduling server provides, on each of the first computing device and the at least one second computing device, a meeting manager interface in connection with the meeting, in operation 608.

If, however, confirmation is not received from the first user, the scheduling server performs a check to determine whether any other responses to the meeting invitation have been received (operation 610). In some implementations, the scheduling server may determine that a confirmation is not received if no confirmation is provided by the first user within a defined threshold time period. For example, if the scheduling server does not receive a confirmation from the first user within a certain amount of time from the time of receiving a meeting acceptance response from the candidate participant, the scheduling server may determine that the first user has not confirmed the meeting details.

In response to determining that there are additional meeting acceptance responses, the scheduling server identifies another one of the second users that responded to the meeting invitation as a candidate participant (operation 612). The scheduling server also updates the actionable option (for the first user to confirm the meeting details) to associate the meeting with this next candidate participant, in operation 614. This iterative process of identifying different candidate participants may be continued until the first user provides confirmation of meeting details with one of the candidate participants. At that point, the scheduling server may provide the meeting manager interface on the first computing device and a computing device of the selected candidate participant.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method, comprising:
receiving, via a first computing device associated with a first user, proposed location information for a meeting;
determining a plurality of second users who are matched with the first user based on a user matching process;
transmitting, to second computing devices associated with the plurality of second users, a meeting invitation containing the proposed location information;
receiving, via at least one of the second computing devices, a response indicating acceptance of the meeting invitation; and
providing, on each of the first computing device and the at least one second computing device, a meeting manager interface in connection with the meeting, the meeting manager interface being configured to indicate identities of the first user and one or more second users associated with the at least one second computing device.

2. The method of claim 1, further comprising receiving, via the first computing device, first meeting criteria, wherein the meeting invitation includes an indication of the first meeting criteria.

3. The method of claim 2, wherein the first meeting criteria relate to one or more of: travel time to the proposed location; preferred payment arrangement; or proposed meeting agenda.

4. The method of claim 1, further comprising:
in response to receiving the response indicating acceptance of the meeting invitation, providing, on the first computing device, a notification of the response.

5. The method of claim 1, further comprising receiving, via the first computing device, confirmation of the meeting by the first user, wherein the meeting manager interface is provided on each of the first computing device and the at least one second computing device responsive to receiving the confirmation.

6. The method of claim 5, wherein the confirmation of the meeting comprises a selection, by the first user, from a list enumerating the plurality of second users.

7. The method of claim 1, wherein the response indicating acceptance of the meeting invitation is received from a plurality of second computing devices and wherein providing the meeting manager interface comprises selecting one of the second computing devices in accordance with defined selection criteria.

8. The method of claim 7, wherein the defined selection criteria relate to one or more of: proximity to the proposed location; time of arrival at the proposed location; time of responding to the meeting invitation; or subscription status of the second users.

9. The method of claim 1, wherein the meeting manager interface includes a selectable option for indicating an expected time of arrival at the proposed location.

10. The method of claim 1, further comprising:
providing, via the meeting manager interface on the first computing device and the at least one second computing device, a prompt for confirmation of arrival status of the one or more second users and the first user, respectively;
obtaining current location data associated with the first user and the one or more second users; and
determining meeting attendance status of the first user and the one or more second users based on the confirmations and the current location data.

11. A computer-implemented method, comprising:
receiving, via a first computing device associated with a first user, a proposed time for a meeting and location criteria;
determining a plurality of second users who are matched with the first user based on a user matching process;
transmitting, to second computing devices associated with the plurality of second users, a meeting invitation indicating the proposed time;
receiving, via at least one of the second computing devices, a response indicating acceptance of the meeting invitation, the response including selection of a first location that satisfies the location criteria; and
providing, on each of the first computing device and the at least one second computing device, a meeting manager interface in connection with the meeting, the meeting manager interface being configured to indicate identities of the first user and one or more second users associated with the at least one second computing device.

12. The method of claim 11, further comprising:
providing, on the at least one second computing device, a location selection interface, wherein the location selection interface is configured to display one or more meeting locations that satisfy the location criteria and wherein the selection of the first location is received via the location selection interface.

13. The method of claim 12, wherein the location selection interface enables search of a database storing location information for a plurality of venues.

14. The method of claim 11, wherein the location criteria include an indication of a maximum radius from a current location associated with the first user.

15. The method of claim 11, further comprising receiving, via the first computing device, first meeting criteria, wherein the first meeting criteria relate to one or more of: travel time to the proposed location; preferred payment arrangement; proposed meeting agenda; or preferred venue type, and wherein the meeting invitation includes an indication of the first meeting criteria.

16. The method of claim 11, further comprising receiving, via the first computing device, confirmation of the meeting by the first user, wherein the meeting manager interface is provided on each of the first computing device and the at least one second computing device responsive to receiving the confirmation.

17. The method of claim 11, wherein the response indicating acceptance of the meeting invitation is received from a plurality of second computing devices and wherein providing the meeting manager interface comprises selecting one of the second computing devices in accordance with defined selection criteria.

18. The method of claim 17, wherein the defined selection criteria relate to one or more of: proximity to the proposed location; time of arrival at the first location; time of responding to the meeting invitation or subscription status of the second users.

19. The method of claim 11, wherein the meeting manager interface includes a selectable option for indicating an expected time of arrival at the proposed location.

20. The method of claim 11, further comprising:
providing, via the meeting manager interface on the first computing device and the at least one second computing device, a prompt for confirmation of arrival status of the one or more second users and the first user, respectively;
obtaining current location data associated with the first user and the one or more second users; and
determining meeting attendance status of the first user and the one or more second users based on the confirmations and the current location data.
